(19) United States
(12) Patent Application Publication
(10) Pub. No.: US 2024/0348974 A1
(43) Pub. Date: Oct. 17, 2024

(54) Directional Loudspeaker with Self-Contained Deployable Waveguide Vanes for Enhancing Directionality and Sound Pressure Level

(71) Applicants: Mark Wynn Perona, San Diego, CA (US); Hernan Frederick Lopez, San Diego, CA (US)

(72) Inventors: Mark Wynn Perona, San Diego, CA (US); Hernan Frederick Lopez, San Diego, CA (US)

(21) Appl. No.: 18/612,946

(22) Filed: Mar. 21, 2024

Related U.S. Application Data
(60) Provisional application No. 63/453,691, filed on Mar. 21, 2023.

(51) Int. Cl. H04R 1/32; H04R 1/02

(52) U.S. Cl. CPC H04R 1/323; H04R 1/026

(57) ABSTRACT

A directional loudspeaker with one or more electroacoustic transducers incorporated into an acoustic waveguide system. The acoustic waveguide system is comprised of a primary, fixed waveguide that is incorporated into the body of the loudspeaker, and a secondary set of one or more acoustic waveguide vanes that can be deployed to extend the size of the primary acoustic waveguide's mouth. When operating with the secondary waveguide vanes deployed, the increased mouth size results in improved acoustic efficiency and a narrower acoustic beam width compared to operation with the secondary waveguides retracted.

### RELATED APPLICATION

This application claims priority to U.S. Provisional Patent Application Ser. No. 63/453,691 for a “Directional loudspeaker with self-contained deployable waveguide vanes for enhancing directionality and sound pressure level” filed Mar. 21, 2023, and currently co-pending, the entirety of which is incorporated herein by reference.

### FIELD OF THE INVENTION

The present invention pertains generally to loudspeaker systems. The present invention is particularly, but not exclusively, useful as an acoustic hailing device capable of broadcasting spoken communications and sounds over long distances.

### BACKGROUND OF THE INVENTION

Systems used for broadcasting audible voice communications and sounds over extended physical distances are commonly referred to as Acoustic Hailing Devices (AHDs). AHD systems are generally comprised of a directional loudspeaker enclosure, power electronics, audio input devices such as a microphone and an audio recording and playback device, as well as mounting systems such as a tripod or mount that attaches the AHD to a vehicle or other platform. The directional loudspeaker in an AHD system produces audible acoustic sound waves that propagate from the loudspeaker in a narrowly focused generally cone-shaped acoustic beam. This focusing of the acoustic output into a narrow-shaped beam increases the acoustic efficiency of the device, enabling it to achieve high on-axis sound pressure levels with relatively low power consumption and therefore a smaller amplifier and power electronics package.

A narrow acoustic beam also enhances the AHD's ability to produce acoustic output that can be clearly heard and understood over long distances. A narrow sound beam can be aimed at a target location to deliver sounds to this target with reduced interference and distortion from echoes or acoustic reflections that would be more severe when using a conventional wide-beamwidth loudspeaker. A narrow sound beam also results in a reduced back wave for the device. The back wave is the amount of Sound Pressure Level measured at 180 degrees from the central axis of the device. By reducing the beam width, the back wave is also reduced, resulting in lowered Sound Pressure Levels behind the device, where the operator is normally positioned, thus exposing the operator to lower Sound Pressure Levels. AHDs achieve this narrowly focused acoustic beam using acoustic waveguides, or horns. The size of the horn mouth is inversely proportional to the acoustic beam width, so AHDs with larger horn mouths produce more narrowly focused acoustic beams than those with smaller horn mouths. Small, light AHDs are highly desirable since a small form factor results in a wider variety of useable scenarios, allowing them to be more easily transported as well as installed and mounted on a wider range of platforms.

While increasing the mouth area of an AHD horn is a relatively inexpensive way of increasing its acoustic efficiency and reducing its beamwidth, the increased size creates disadvantages when fielding and operating these types of devices. AHDs are deployed and used in a wide variety of applications and the availability for use of an AHD is largely dependent on the ease with which it is transported, stowed and deployed. Smaller, lighter AHDs that can be more easily carried, mounted or transported are more likely to be deployed in a larger number of applications.

### SUMMARY OF THE INVENTION

Disclosed is directional loudspeaker for an acoustic hailing device (AHD). The loudspeaker has an enclosure containing one or more acoustic transducers coupled with an acoustic waveguide system whose geometry can be adjusted to increase the mouth size of the waveguide system resulting in increased acoustic efficiency and reduced acoustic beam width. The loudspeaker incorporates a deployable waveguide system can be extended or retracted in order to increase or decrease the mouth size of the waveguide and alter the acoustic efficiency, beam width and back wave of the AHD's acoustic output.

More particularly, a preferred embodiment of the loudspeaker has one or more electroacoustic transducers incorporated into an acoustic waveguide system. The acoustic waveguide system is comprised of a primary, fixed waveguide that is incorporated into the body of the loudspeaker, and a secondary set of one or more acoustic waveguide vanes that can be deployed to extend the size of the primary acoustic waveguide's mouth. When operating with the secondary waveguide vanes deployed, the increased mouth size results in improved acoustic efficiency and a narrower acoustic beam width compared to operation with the secondary waveguides retracted.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a front perspective view of a preferred embodiment of a directional loudspeaker with self-contained deployable waveguide vanes for enhancing directionality and sound pressure level with the waveguide vanes in the retracted position;

FIG. 2 is a front perspective view of the directional loudspeaker with the waveguide vanes shown in the deployed position;

FIG. 3 is a rear perspective view of the directional loudspeaker with the waveguide vanes shown in the retracted position; and

FIG. 4 is a rear perspective view of the directional loudspeaker with the waveguide vanes shown in the deployed position.

### DETAILED DESCRIPTION

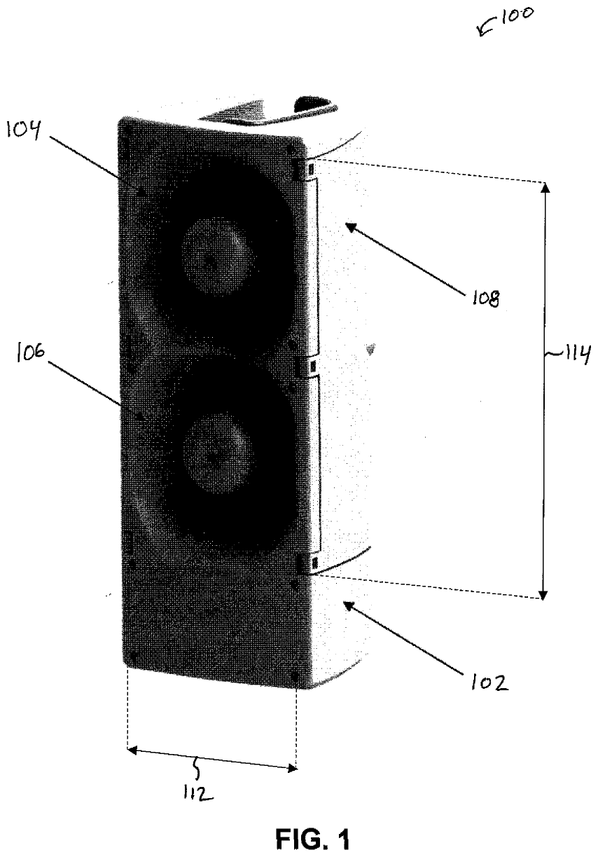

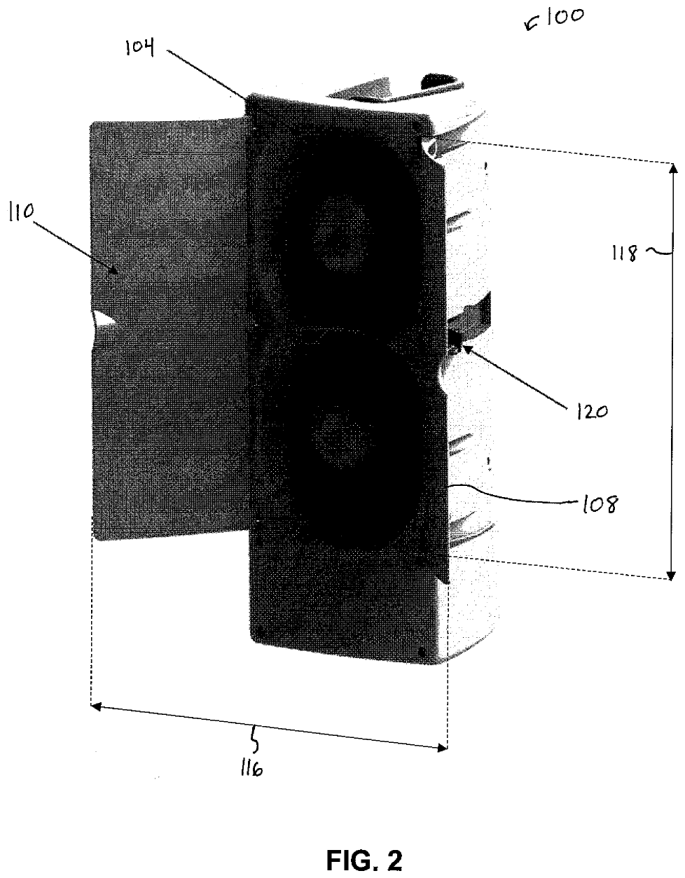

Referring initially to FIG. 1, a preferred embodiment of an acoustic hailing device (AHD) with an integral deployable waveguide is illustrated and generally designated loudspeaker 100. Loudspeaker 100 has a body 102 containing electroacoustic transducers, and electronic systems. Integral to body 102 are primary acoustic waveguides 104 and 106 produce a sound pressure level and acoustic beam width that is determined by the design of primary acoustic waveguides 104 and 106. It will be appreciated by one skilled in the art that embodiments can be made with a single speaker and single primary acoustic waveguide 104, or with greater numbers of speakers and waveguides; such embodiments are fully contemplated herein. Secondary waveguide vanes 108 and 110 (shown in FIG. 2) are also integrated into body 102 and shown in a reduced-footprint configuration, which is a retracted configuration in the illustrated embodiment, in which loudspeaker 100 fills a reduced volume, making it more easily transported and stored.

When secondary waveguide vanes 108 and 110 are in the retracted configuration, primary acoustic waveguides 104 and 106 are completely functional, and loudspeaker 100 can be used to acoustically broadcast information and sounds with the acoustic characteristics that are determined by the design of the primary acoustic waveguides 104 and 106. The acoustic efficiency and acoustic beam width of loudspeaker 100 is generally related to the total surface area of the primary waveguide system mouth. Width 112 and height 114, multiplied together, define an approximate total surface area of the primary waveguide system mouth.

Acoustic efficiency is the amount of Sound Pressure Level measurable at a given distance along the central axis of the loudspeaker for a given input power level. Acoustic beamwidth is defined as the rotational angle measured from the central axis of the loudspeaker at which the Sound Pressure Level is reduced by 6 dB relative to the on-axis Sound Pressure Level. The body 102 of loudspeaker 100 houses one or more electroacoustic transducers, primary acoustic horns or waveguides 104 and 106 formed into body 102, and secondary acoustic waveguide vanes 108 and 110 (shown in FIG. 2) that can be retracted and stowed to reduce the overall projected area of the housing or enclosure defined by body 102, or deployed to extend the primary waveguides 104 and 106 to favorably modify the acoustic performance of the loudspeaker.

The primary acoustic waveguides 104 and 106 control the expansion rate of the acoustic signal from the transducers, amplifying the sound pressure level of the acoustic signal from the transducers, and shaping the acoustic output into a narrowly focused acoustic beam.

Body 102 also incorporates one or more deployable secondary waveguide vanes 108 and 110. These waveguide vanes 108 and 110 can be retracted to reduce the overall projected area of body 102. When retracted, the waveguide vanes 108 and 110 are attached to body 102 in a preferred embodiment, such as the illustrated embodiment, and are detached from the enclosure in an alternate embodiment. When deployed, the waveguides attach around the mouth or the primary waveguide 104 and 106 of body 102 of loudspeaker 100, extending the mouth size (see FIG. 2).

Referring now to FIG. 2, loudspeaker 100 is illustrated with secondary waveguide vanes 108 and 110 in a deployed configuration. In this configuration, the primary acoustic waveguides 104 and 106 are augmented by the deployment of the integral secondary acoustic waveguide vanes 108 and 110. When deployed, these vanes 108 and 110 extend the primary waveguides 104 and 106 and widen the mouth of the overall waveguide system. This results in higher acoustic efficiency and a reduced acoustic beam width.

In a preferred embodiment, secondary waveguide vanes 108 and 110 are a set of formed rigid panels are attached to the loudspeaker enclosure by a hinge system 120 that positions the waveguide vanes 108 and 110 around the mouth of the primary waveguides 104 and 106 and allows the vanes 108 and 110 to fold back onto the exterior of the body 102 of loudspeaker 100 to reduce the projected area of the body 102 of loudspeaker 100. In some preferred embodiments, a mechanical actuator is used to deploy and stow waveguide vanes 108 and 110 between the deployed configuration and the retracted configuration.

Alternate embodiments of the secondary waveguide system include inflatable semi-rigid waveguides, adjustable detent cams, electronically adjustable positioners, detachable secondary waveguides and additional expandable waveguide vanes that can extend beyond the secondary waveguides. In an embodiment having inflatable waveguides, the inflatable waveguide vanes can be deflated and folded flat for storage and shipping and inflated to improve the acoustic characteristics of the loudspeaker

In the deployed configuration, the secondary waveguide vanes 108 and 110 cause the waveguide system to produce a longer acoustic path length and a wider waveguide mouth. In particularly, deployed waveguide vanes 108 and 110 increase the total surface area of the waveguide system mouth, as shown by width 116 and height 118. Width 117 in the deployed configuration is wider than width 112 (shown in FIG. 2) in the retracted configuration and results in a larger surface area. The larger surface area generally produces improved acoustic efficiency, that is, a higher sound pressure level for a given input power. The larger surface area generally produces a narrower acoustic beam width.

In a preferred embodiment, a locking hinge system 120 is used to lock waveguide vanes 108 and 110 in the deployed configuration, enhancing the acoustic characteristics of loudspeaker 100.

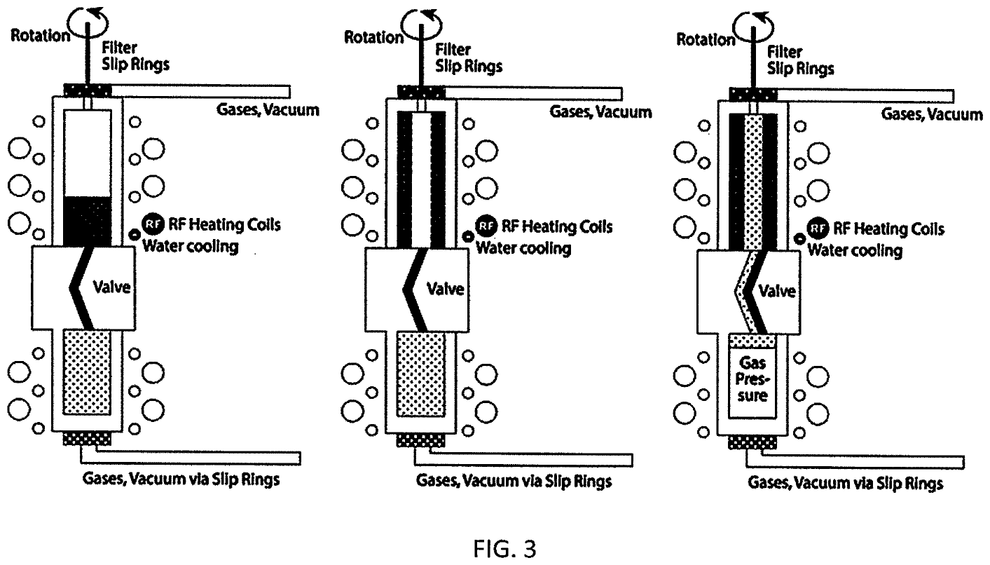

Referring now to FIG. 3, a rear view of loudspeaker 100 with secondary waveguide vanes 108 and 110 in the retracted configuration is shown. Exemplary features present in some preferred embodiments of loudspeaker 100 are shown, such a handle 122, volume control 124, audio jacks 126, and Bluetooth radio 128. Bluetooth radio 128 allows for wireless streaming of an audio signal to loudspeaker 100. It will be apparent that other wireless protocols and corresponding radios can be used in place of, or together with, Bluetooth radio 128; such embodiments are fully contemplated herein. Moreover, the list of exemplary features is not intended to be exclusive of other features that may be incorporated into loudspeaker 100.

Some preferred embodiments of loudspeaker 100 contain some or all of the following features: audio amplifiers; power supplies that accept AC and/or DC power input and convert this power as required to power the amplifiers and other electronics in the device; a fixed or removeable rechargeable battery to power the device; a battery charging circuit and battery level monitoring circuit; an operator control interface with controls such as power on/off, volume, and other operator adjustable controls; one or more rigid mounting points 130 for attaching the loudspeaker 100 to a mounting platform and/or attaching accessories to loudspeaker 100; interface connectors for power as well as attachable accessories such as microphones and audio storage and playback devices; wireless interfaces for connection to wireless accessories such as microphones and audio storage and playback devices; displays and indicators to provide system status information to the user; audio recording and playback device.

Loudspeakers 100 with bodies 102 of different shapes, for example, rectangular, round, hexagonal, or other shapes, are fully contemplated herein, and such embodiments include a number and shape of secondary waveguide vanes suitable to the shape of loudspeaker 100.

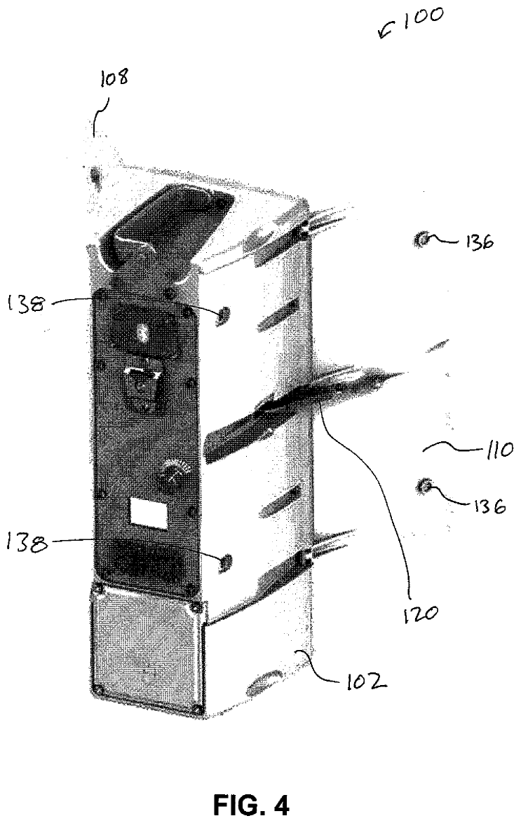

Referring now to FIG. 4, a rear view of loudspeaker 100 is shown with secondary waveguide vanes 108 and 110 in the deployed configuration. Locking hinge system 120 maintaining vane 110 in the deployed configuration is visible in this view; a corresponding locking hinge system 120 (shown in FIG. 2) is present on the opposite side of body 102 and maintains vane 108 in the deployed configuration.

An attachment mechanism, using attachment members 136 on vanes 108 and 110 and attachment members 138 on body 102, is used in some preferred embodiments to hold vanes 108 and 110 in the retracted configuration so that vanes 108 and 110 are not accidentally deployed until a user is ready to place them in the deployed configuration. In a preferred embodiment, attachment members 136 and attachment members 138 are magnetic connectors. In an alternate preferred embodiment, attachment members 126 and attachment members 138 are snap connectors.

While there have been shown what are presently considered to be preferred embodiments of the present invention, it will be apparent to those skilled in the art that various changes and modifications can be made herein without departing from the scope and spirit of the invention.

What is claimed is:

1. A directional loudspeaker for an acoustic hailing device, comprising:
an enclosure comprising a primary waveguide system integrated into the enclosure; and
a set of secondary waveguide vanes capable of changing between a reduced-footprint configuration and a deployed configuration,
wherein a waveguide mouth of the loudspeaker has a first size defined by the primary waveguide system when the set of secondary waveguide vanes is in the reduced-footprint configuration, and
wherein the waveguide mouth of the loudspeaker has a second size defined by the primary waveguide system and the set of secondary waveguide vanes when the set of secondary waveguide vanes is in the deployed configuration, the second size greater than the first size.

2. The directional loudspeaker for an acoustic hailing device as recited in claim 1, wherein the reduced-footprint configuration of the set of secondary waveguide vanes comprises a retracted configuration in which the secondary waveguide vanes of the set of secondary waveguide vanes are placed against sides of the enclosure.

3. The directional loudspeaker for an acoustic hailing device as recited in claim 2, further comprising an attachment mechanism configured to prevent accidental placement of the set of secondary waveguide vanes into the deployed configuration.

4. The directional loudspeaker for an acoustic hailing device as recited in claim 3, wherein the attachment mechanism comprises first attachment members on the set of secondary waveguide vanes and second attachment members on the enclosure.

5. The directional loudspeaker for an acoustic hailing device as recited in claim 4, wherein the first attachment members and the second attachment members comprise magnetic connectors.

6. The directional loudspeaker for an acoustic hailing device as recited in claim 4, wherein the first attachment members and the second attachment members comprise snap connectors.

7. The directional loudspeaker for an acoustic hailing device as recited in claim 2, further comprising a locking hinge system attached to each secondary waveguide vane of the secondary waveguide vane system and configured to hold the secondary waveguide vane system in the deployed configuration.

8. The directional loudspeaker for an acoustic hailing device as recited in claim 1, wherein the reduced-footprint configuration of the set of secondary waveguide vanes comprises a configuration in which the set of secondary waveguide vanes is removed from the enclosure.

9. The directional loudspeaker for an acoustic hailing device as recited in claim 1, wherein the set of secondary waveguide vanes reduce or displace the back wave of the device, resulting in reduced sound pressure level at an operator's position, while the set of secondary waveguide vanes is in the deployed configuration.

10. The directional loudspeaker for an acoustic hailing device as recited in claim 1, further comprising a handle at the top of the enclosure.

11. A loudspeaker for an acoustic hailing device, comprising:
a body;
one or more primary waveguides integrated into the body and defining a first waveguide mouth; and
secondary waveguide vanes attached to the body by a locking hinge system and moveable between a retracted position and a deployed position,
wherein the secondary waveguide vanes define an enhanced waveguide mouth when in the deployed position, the enhanced waveguide mouth having greater surface area than the first waveguide mouth and providing improved acoustic efficiency.
